(19) United States
(12) Patent Application Publication
(10) Pub. No.: US 2004/0228709 A1
(43) Pub. Date: Nov. 18, 2004

(54) Article conveying apparatus

(75) Inventor: Yuichi Ueda, Komaki-shi (JP)

Correspondence Address: KUSNER & JAFFE, HIGHLAND PLACE SUITE 310, 6151 WILSON MILLS ROAD, HIGHLAND HEIGHTS, OH, 44143, US

(73) Assignee: Daifuku Co. Ltd.

(21) Appl. No.: 10/796,487

(22) Filed: Mar. 9, 2004

(30) Foreign Application Priority Data
Mar. 20, 2003 (JP) 2003-076666

(51) Int. Cl. B65G 1/00

(52) U.S. Cl. 414/279

(57) ABSTRACT

An apparatus conveying apparatus includes a lower frame (2) that runs along a running rail (1), a platform (3) provided with a fork device (5) that transfers an article (F), and a longitudinal pair of raising and lowering masts connected perpendicularly to the lower frame (2) to guide and support the platform (3) so that the platform can freely ascend and descend. The lower frame (2) and the raising and lowering masts (4) are each formed of a square cylinder. A lower end of the cylinder forming each of the raising and lowering masts (4) is connected to a longitudinal side of the cylinder forming the lower frame (2).

### FIELD OF THE INVENTION

The present invention relates to an article conveying apparatus that conveys articles between a plurality of article storage sections on shelves on which the articles are housed and a predetermined entry and exit port.

### BACKGROUND OF THE INVENTION

As a conventional article conveying apparatus of this kind, Japanese Patent Publication No. 5-67530 discloses a stacker crane configured as described below.

This stacker crane comprises a lower frame (a running truck body) that guides a running rail (a track forming a specified path), a platform including a fork device (a transfer device) that transfers an article, a longitudinal pair of raising and lowering masts (raising and lowering poles) which is provided on the lower frame and extends vertically so as to guide and support the platform to be capable of freely ascending and descending, and an upper frame (an upper truck body) that connects upper ends of the raising and lowering masts together.

The platform is suspended and supported using a pair of raising and lowering chains for raising and lowering the platform, each connected to the upper part of the corresponding one of the longitudinally opposite sides of the platform. Each of the raising and lowering chains is guided to a guide sprocket provided between the upper frame and the upper end of one of the raising and lowering mast and then to a winding drum (a driving wheel) provided outside the above raising and lowering mast. The raising and lowering chain is further guided to a guide sprocket provided on each of the longitudinally opposite sides of the lower frame at its lower position. The raising and lowering chain is then guided upward and connected to the lower longitudinally opposite sides of the platform.

The lower frame is provided with a longitudinal pair of wheels that can run along the running rail, a running drive unit connected to one (driving wheel) of the wheels constituting the pair to allow the running truck body to run, and an raising and lowering drive unit connected to the winding drum to feed and wind the raising and lowering chains. These components are provided outside the raising and lowering masts. A control panel for the stacker crane is installed on the lower frame and outside the raising and lowering mast opposite to the one that feeds and winds the raising and lowering chains. The control panel faces frontward and is supported by the raising and lowering mast.

In the conventional stacker crane, the raising and lowering masts are provided on the lower frame and extends in the vertical direction. Accordingly, since “it is difficult to mount the wheels under the raising and lowering masts” and the “stacker crane runs unstably when the wheels are mounted in the lower frame inside the corresponding raising and lowering masts”, the wheels are located outside the corresponding raising and lowering masts in the lower frame. Thus, the stacker crane has an increased length (machine length) owing to these outside portions. Accordingly, when articles are transferred to the article storage sections located at the opposite ends of the shelf, parts of the stacker crane which are located outside the raising and lowering masts protrude from the space in the shelf in which the article house sections are provided. Consequently, the article storage sections of the shelf cannot be provided opposite these protruding parts. Therefore, when the automatic warehouse facility is located in a small space, it may be difficult to ensure a required shelf storage volume.

### SUMMARY OF THE INVENTION

An advantage of the present invention is an article conveying apparatus that enables the machine length to be reduced.

An article conveying apparatus according to the present invention comprises a running truck body formed of a square cylinder and running along a track, a platform provide with a transfer device that transfers articles, and a pair of poles for raising and lower the platform, each of which is formed of a square cylinder and connected perpendicularly to the running truck body to guide and support the platform, so that the platform can freely ascend and descend. The cylinder forming each of the raising and lowering poles is connected, at its lower end part, perpendicularly to a longitudinal side of the cylinder forming the running truck body. This configuration enables wheels supporting the running truck body to be mounted to the cylinder forming the running truck body located to oppose the raising and lowering poles. It is thus possible to reduce the machine length of the article conveying apparatus while ensuring the safety during running.

### BRIEF DESCRIPTION OF THE DRAWINGS

FIG. 1 is a perspective view of an automatic warehouse facility comprising a stacker crane according to an embodiment of the present invention;

FIG. 2 is a schematic side view of the stacker crane;

FIG. 3 is an enlarged side view of essential parts of the stacker crane;

FIGS. 4A and 4B are a lower front view and a lower rear view of the stacker crane;

FIG. 5 is a plan view of a lower frame of the stacker crane;

FIGS. 6A, 6B, and 6C are a plan view, a side view, and a front view of the upper frame of the stacker crane;

FIG. 7 is a view illustrating how raising and lowering chains of the stacker crane are extendedly installed;

FIGS. 8A and 8D are a plan view and a side view of a chain tensioner of the stacker crane;

FIGS. 9A and 9B are a side view and a rear view of a running drive section of the stacker crane;

FIGS. 10A and 10B of a plan view and a side view of a wheel unit of the stacker crane;

FIG. 11 is a sectional view of a driving wheel unit of the stacker crane;

FIGS. 12A and 12B are a side view and a partial sectional view of a torque arm of the stacker crane;

FIGS. 13A and 13B are views showing how the torque arm of the stacker crane is assembled; and

FIG. 14 is a block diagram showing how control is provided in an automatic warehouse facility comprising the stacker crane.

### DETAILED DESCRIPTION OF A PREFERRED EMBODIMENT

An embodiment of the present invention will be described below with reference to the drawings.

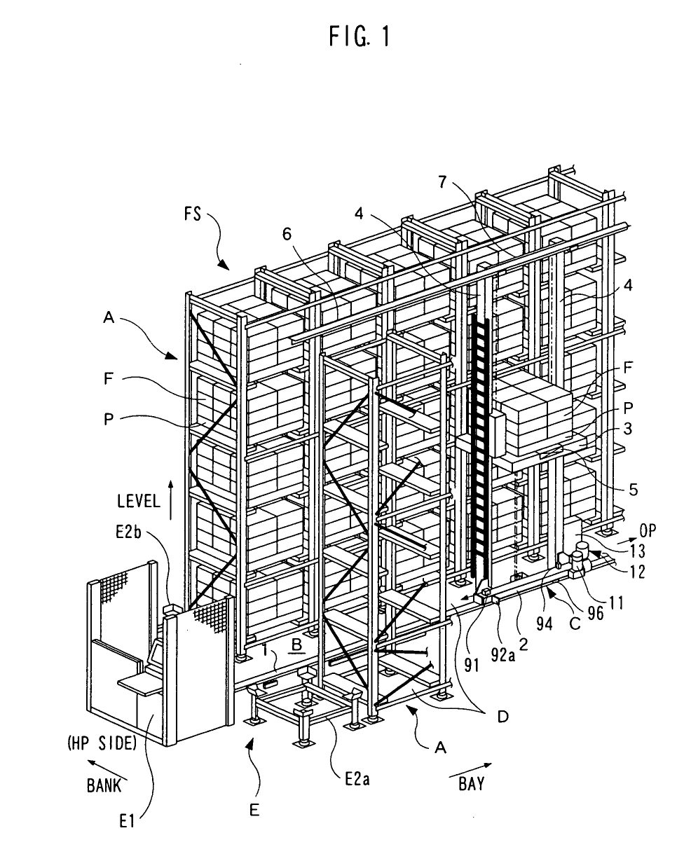

FIG. 1 is a schematic perspective view of an automatic warehouse facility comprising an article conveying apparatus according to the embodiment of the present invention.

As shown in FIG. 1, an automatic warehouse facility FS is provided with two storage shelves A installed with a spacing between them so that articles are transferred in opposite directions, and a stacker crane (an example of an article conveying apparatus) C that runs automatically along a work passage B formed between the storage shelves A. Each of the storage shelves A is provided with a plurality of article storage sections (an example of article storage sections for storing articles) D that store pallets P on which articles (merchandise or the like) F are placed, the article storage sections being arranged in a vertical direction and in a direction in which the stacker crane C runs (this direction will hereinafter be referred to as a “longitudinal direction”).

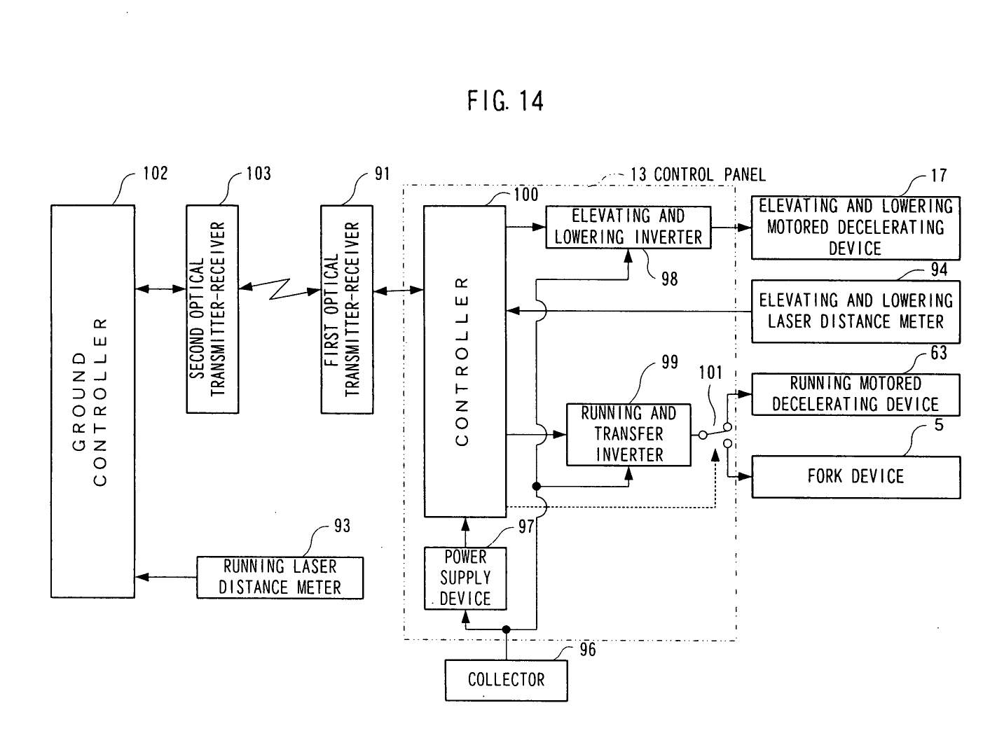

A running rail (an example of a track) 1 is installed in the work passage B along a longitudinal direction of the storage shelves A. A ground control panel E1 is provided in an article input and output section E installed at one end (a home position side of the stacker crane: HP side) of the work passage B. The ground control panel E1 contains a ground controller 102 (FIG. 14) to control the stacker crane C to transfer the articles F between the entry and exit port and the article storage sections D and to manage the article F stored in each article storage section D. A pair of article cradles E2 (E2a and E2b) is provided across the running rail 1 so as to form an article handling unit and the entry and exit port. The stacker crane C, which runs along the running rail 1 on the basis of entry and exit data, is configured as a carriage that conveys and transfers the articles F between the article cradles E2 and the article storage sections D.

The position (shelf number: information that identifies the article storage section D) of each article storage section D within the storage shelf A is identified by the number of a bank (the number of the corresponding column of the storage shelf A), the number of a level (the number of corresponding level of the article storage section D counted from the lowest one of the storage shelf A), and the number of a bay (the number of the article storage section D relative to the HP position in the longitudinal direction).

The entry and exit data on the article storage section is composed of an “operation mode (information on an operation to be performed which information specifies an input operation, an output operation, or a picking operation), an “article cradle E2 to be used (either the right or left one is specified)”, and a “shelf number (indicative of the bank, bay, and level of the article storage section D on which the operation is performed)”.

The stacker crane C comprises a lower frame (an example of a running truck body) 2 that runs along the article storage sections D and running rail 1, a platform 3 provided with a fork device (an example of a transfer device) 5 that transfers the pallets P (articles F) between the article storage sections D and the article cradles E2, a longitudinal raising and lowering pair of masts (poles) 4 for raising and lowering the platform 3 which are connected vertically to the lower frame 2 to guide and support the platform 3 so that the platform 3 can freely ascend and descent, and an upper frame (an example of an upper truck body) 7 to which top part of the longitudinal pair of raising and lowering masts 4 is connected. The upper frame 7 is guided along a guide rail (an example of an upper track) 6 laid on a ceiling to face toward the running rail 1 and along the longitudinal direction of the storage shelves A. The upper frame 7 thus regulates the top position of the stacker crane C as it runs. The fork device 5 is based on a fork system using a running fork.

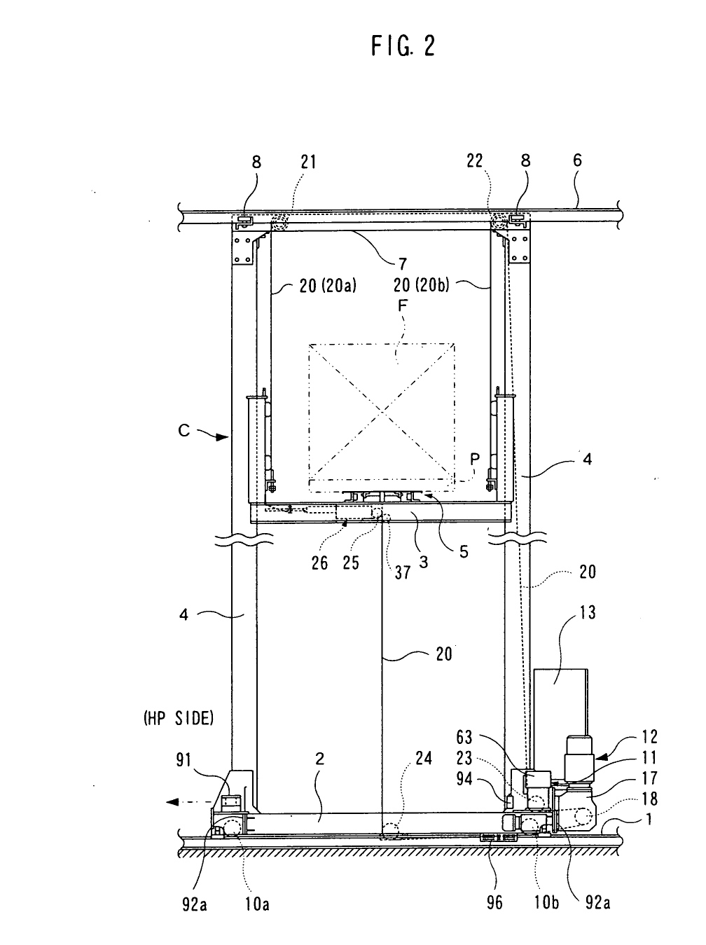

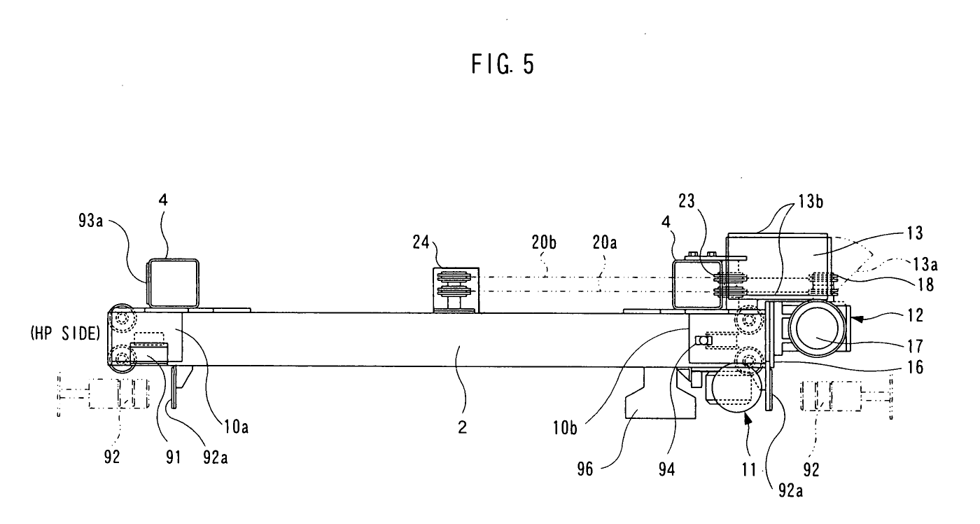

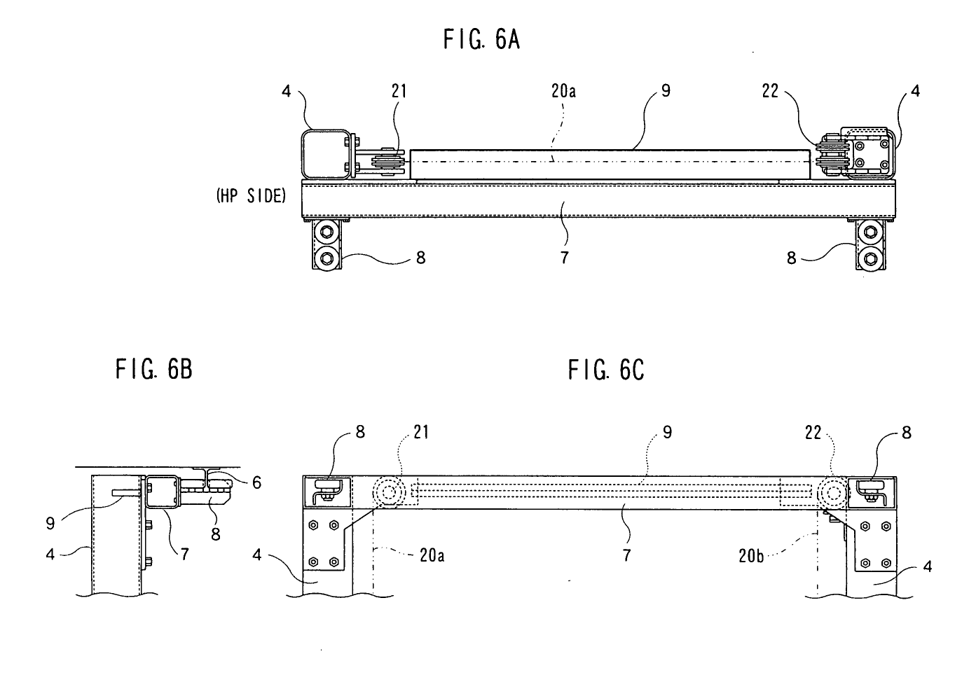

As shown in FIGS. 2 to 6, the lower frame 2, the longitudinal pair of raising and lowering masts 4, and the upper frame 7 are each formed of a square pipe (an example of a square cylindrical member). A longitudinal side of the lower end of the square pipe forming each raising and lowering mast 4 is connected to a longitudinal side of the corresponding end of the square pipe forming the lower frame 2. A longitudinal side of upper end of the square pipe forming each raising and lowering mast 4 is connected to a longitudinal side of the corresponding end of the square pipe forming the upper frame 7. The square pipe forming the upper frame 7 and the square pipe forming the lower frame 2 are arranged on the same side of the square pipe forming each raising and lowering mast 4 as shown in FIGS. 5 and 6.

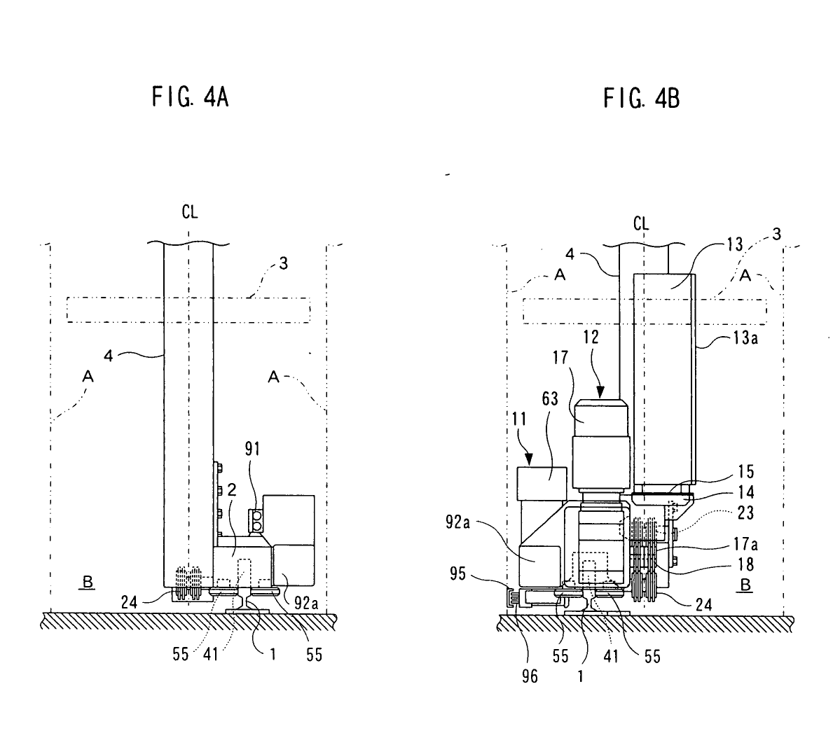

As shown in FIG. 4, a central position CL of each raising and lowering mast 4 in a lateral direction (that is perpendicular to the longitudinal direction in which the stacker crane C runs) is a substantially central position of the stacker crane C in the lateral direction. This substantially central position coincides with a substantially central position of the work passage B between the storage shelves A. As a result, the running rail 1, located in the lateral center of the lower frame 2, is laid offset from the central position of the work passage B.

As shown in FIG. 6, upper guide rollers 8 constituting a lateral pair are provided on the longitudinal side of the longitudinally opposite ends of the upper frame 7 which side is opposite the raising and lowering masts 4. The guide rail 6 is pinched in the upper guide rollers 8 to regulate the top position of the stacker crane C as it runs. An upper frame cover 9 is provided on a longitudinal side of the upper frame 2 on which the raising and lowering masts 4 are provided and between the pair of raising and lowering masts 4.

As shown in FIGS. 2 to 5, a longitudinal pair of wheel units 10 is arranged in the square pipe forming the lower frame 2 and at substantially the same positions (the opposite ends of the square pipe forming the lower frame 2) as those where the raising and lowering masts 4 are connected to the lower frame 2 so that these positions coincide with each other. The wheel units 10 support the wheels 41 that support the lower frame 2 and are guided along the running rail 1. The front (HP side) wheel unit 10 is a driven wheel unit 10a, whereas the rear (an out-position (OP) side longitudinally opposite to the HP side) wheel unit 10 is a driving wheel unit 10b. A running drive device 11 is arranged near the driving wheel unit 10b and on the longitudinal side of the square pipe forming the lower frame 2 which side is opposite the one to which the raising and lowering mast 4 is connected. The running drive device 11 is connected to an axel 41a of a wheel 41 of the driving wheel unit 10b to drive the wheel 41.

An raising and lowering drive device 12 is arranged on a latitudinal side of the rear end (OP side) of the square pipe forming the lower frame 2 to elevate and lower the platform 3. A horizontal supporting member 14 is attached to the square pipe forming the lower frame 2 outside the OP side of the square pipe forming the raising and lowering mast 4. A control panel 13 for the stacker crane C is arranged on the horizontal supporting member 14. A swinging door 13a is formed in a longitudinal OP side of the control panel 13. The control panel 13 is attached to the horizontal supporting member 14 via a vibration isolating rubber 15. Swingable doors 13b are provided, using bolts, on sides of the control panel A which face the respective storage shelves A. The control panel 13 is self-standing.

The raising and lowering drive device 12 is composed of a motored decelerating device 17 fixed to a vertical panel 16. The raising and lowering drive device 12 is fixed to the rear end of the lower frame 2 via the vertical panel 16 so that a rotating drive shaft 17a of the motored decelerating device 17 faces in the lateral direction and its rotational center is lower than the top surface of the lower frame 2 and protrudes toward the raising and lowering mast 4. A lateral pair of winding sprockets (an example of driving wheels) 18 is fixed to the rotating drive shaft 17a (projecting portion). As a result, the winding sprockets 18 are located at the rear (OP side) end (an example of the longitudinal end) of the lower frame 2 and outside the longitudinal side of the lower frame 2 to which side the raising and lowering mast 4 is connected. The winding sprockets 18 are also arranged substantially at the height of the top surface of the lower frame 2.

As shown in FIGS. 2 to 6, the platform 3 is suspended and supported by a pair of raising and lowering chains 20 each having one end connected to the upper part of the corresponding one of the longitudinally opposite sides of the platform 3. A first guide sprocket (an example of a first guide wheel) 21 is provided above one (HP side) of the raising and lowering masts 4 to guide one chain 20a of the raising and lowering chains 20 constituting the pair, from the upper front (HP) end of the platform 3 in the horizontal direction. A pair of second guide sprockets (an example of second guide wheels) 22 is provided above the other (OP side) raising and lowering mast 4 to guide downward the chain 20a guided from the first guide sprocket 21, while guiding the other chain 20b of the pair of raising and lowering chains 20 downward from the upper rear (OP side) end of the platform 3. A pair of third sprockets (an example of third guide wheels) 23 is provided below the other raising and lowering mast 4 to guide, to a winding sprocket 18, the pair of raising and lowering chains 20a and 20b guided from the respective second guide sprockets 22 through a hollow portion of the square pipe of the other raising and lowering mast 4. A pair of fourth guide sprockets (an example of fourth guide wheels) 24 is provided on the longitudinal side of the lower frame 2 on which the raising and lowering masts 4 are provided and near the center of the lower frame 2. The fourth guide sprockets 24 guide a returning part of the pair of raising and lowering chains 20a and 20b guided from the pair of winding sprockets 18.

A pair of fifth sprockets (fifth guide wheels) 25 is provided below the vicinity of the center of the platform 3 to guide, in the horizontal direction, the returning part of the pair of raising and lowering chains 20a and 20b guided in the vertical direction from the pair of fourth guide sprockets 24. The other ends of the raising and lowering chains 20a and 20b guided in the horizontal direction from the pair of fifth guide sprockets 25 are arranged in the platform 3 and connected to a chain tensioner (an example of a tension setting device) 26 that sets the tension of the pair of raising and lowering chains 20a and 20b.

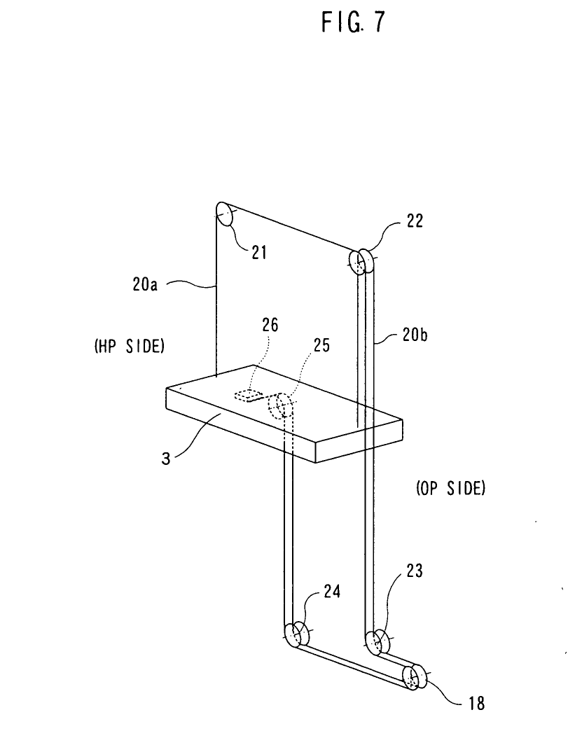

As shown in FIG. 7, one chain 20a of the pair of raising and lowering chains 20 is guided from the upper front (HP side) end of the platform 3 to the fourth guide sprocket 24, located in the center of the lower frame 2, via the first guide sprocket 21, located above the raising and lowering masts 4, the second guide sprocket 22, the third guide sprocket 23, located below the other raising and lowering mast 4, and the winding sprocket 18, which feeds and winds the chains. The chain 20a is further guided vertically to the center of the platform 3 (from below) and then connected to the chain tensioner 26 via the fifth guide sprocket 25, located in the lower part of the center of the platform 3.

The other 20b of the pair of raising and lowering chains 20 is guided from the upper rear (OP side) end of the platform 3 to the fourth guide sprocket 24, located in the central portion of the lower frame 2, via the second guide sprocket 22, located above the other raising and lowering masts 4, the guide sprocket 23, located below this raising and lowering mast 4, and the winding sprocket 18. The chain 20b is further guided vertically to the center of the platform 3 (from below) and then connected to the chain tensioner 26 via the fifth guide sprocket 25, located in the lower part of the center of the platform 3.

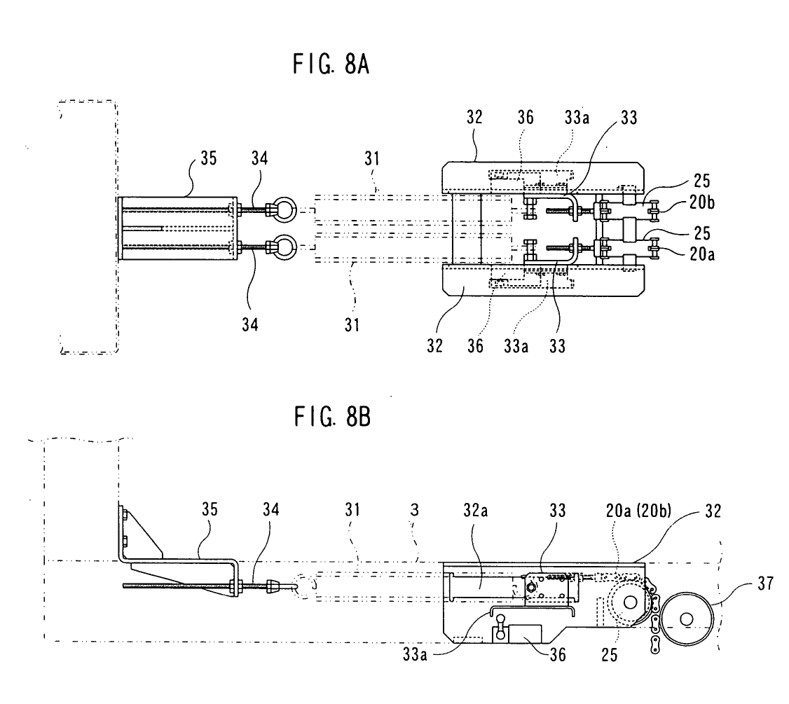

As shown in FIG. 8, the chain tensioner 26 is composed of a tension spring (an example of a spring) 31, a tensioner bracket 32, a dog (an example of a moving member) 33, a chain bolt (an example of a setting jig) 34, a chain bolt bracket 35, a lever type limit switch (an example of a detector or an error detecting unit) 36, and a lower idler 37.

A lateral pair of the tension springs 31 is provided so that the springs 31 set the tensions of the raising and lowering chains 20a and 20b, respectively.

A lateral pair of the tensioner brackets 32 is provided so that the brackets 32 support the respective rotating shafts of the pair of fifth guide sprockets 25 level in the lateral direction.

A lateral pair of the dogs 33 is provided so that the dogs 33 can be moved in the horizontal direction along respective horizontal grooves 32a formed in the tensioner brackets 32. The other end of the raising and lowering chain 20a or 20b guided horizontally by the fifth guide sprocket 25 is connected to one end of each dog 33. One end of each tension spring 31 is connected to the other end of the corresponding dog 33.

A lateral pair of the chain bolts 34 is provided so that the other end of each tension spring 31 is connected to the corresponding chain bolt 34 to set the tension of raising and lowering chain 20a or 20b.

The chain bolt bracket 35 supports the chain bolts 31.

A lateral pair of the lever type limit switches 36 is provided so that each switch 36 is activated by a channel shaped member 33a attached level to the lower end of the corresponding dog 33. The lever type limit switch 36 thus detects an error in the elongation of the raising and lowering chain 20a or 20b on the basis of the position to which the dog 33 has been moved. The lever type limit switch 36 thus detects that the raising and lowering chain 20a or 20b has been cut.

A lateral pair of the lower idlers 37 are provided so as to prevent the raising and lowering chains 20a and 20b guided to the fifth guide sprockets 25 from swinging backward (toward the OP side) and then being disengaged from the sprockets.

With the configuration of the chain tensioner 26, the tensions of the raising and lowering chains 20a and 20b are adjusted by controlling the feed length of the pair of connected chain bolts 34 via the dogs 33 and the tension springs 31. Furthermore, when an error occurs in the elongation of the raising and lowering chain 20a or 20b (the chain has gone slack due to a secular change) or the chain 20a or 20b is cut, the limit switch 36 is activated to detect the error in the raising and lowering chain 20a or 20b.

The wheel unit 10 (driven wheel unit 10a and driving wheel unit 10b) will be described below.

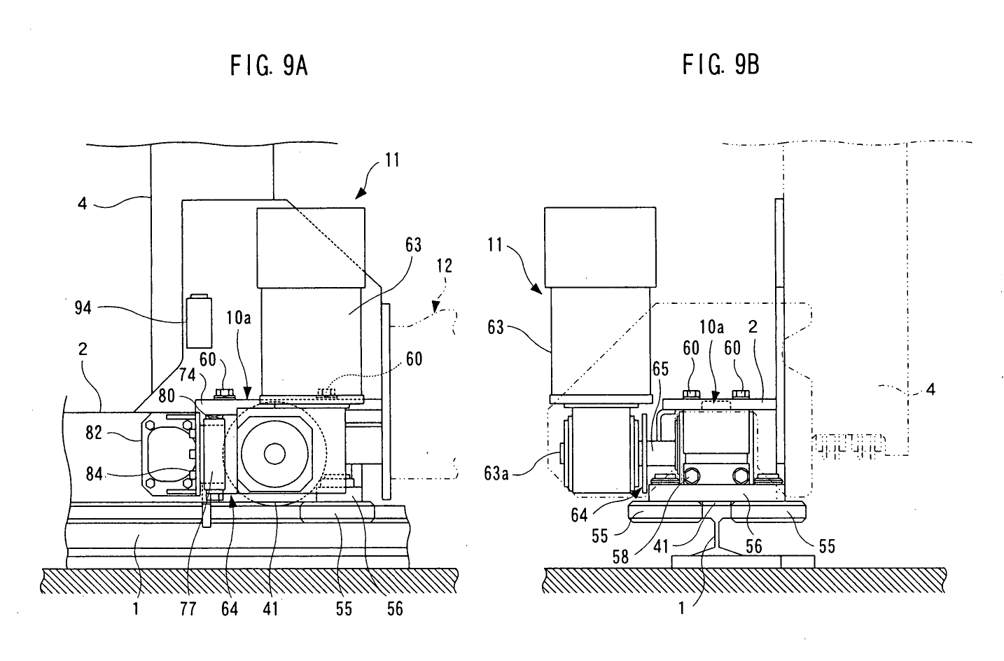

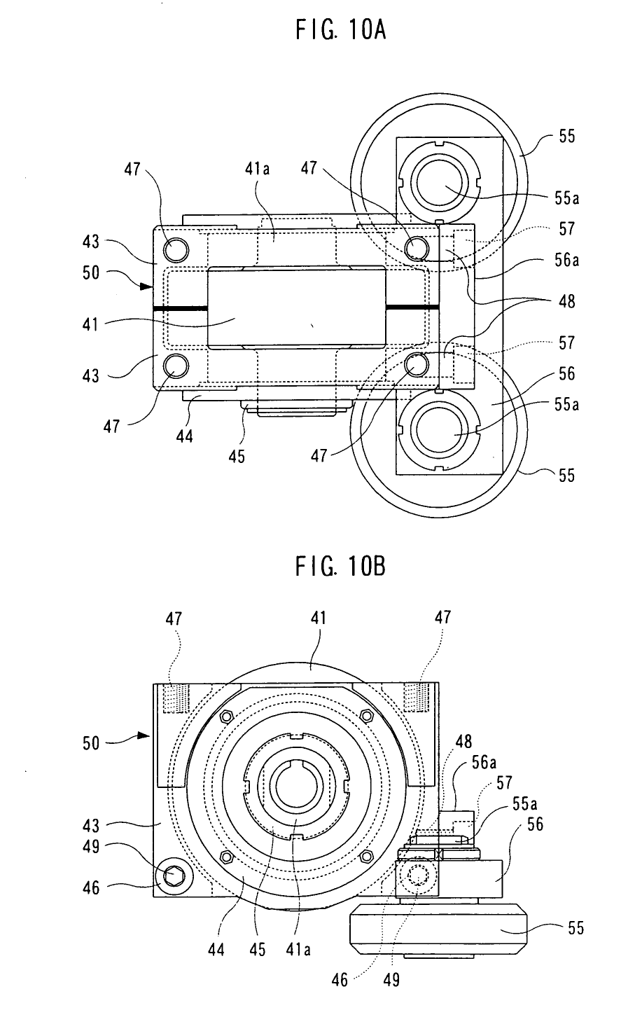

As shown in FIGS. 9 to 11, the wheel unit 10 has an integral structure including the wheel 41 which supports the lower frame 2 and which is guided along the running rail 1 and a lateral pair of guide rollers (an example of guide wheels) 55 arranged in a lateral direction perpendicular to the longitudinal direction. The wheel unit 10 can be mounted in the square pipe forming the lower frame 2.

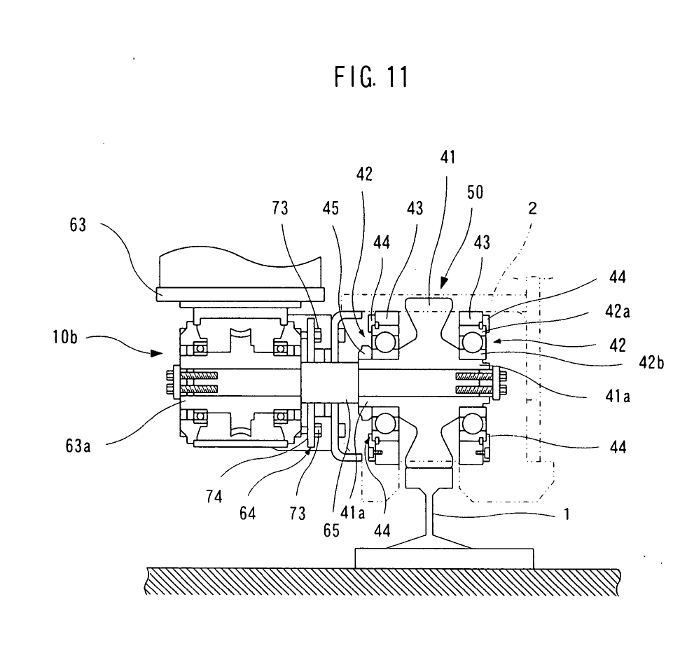

That is, the axel (rotating shaft) 41a of the wheel 41 is rotatably supported level by a pair of bearings 42 supported by a pair of exclusive wheel housings (an example of frames) 43. As shown in FIG. 11, an outer ring 42a of each bearing 42 is externally fixed by a presser member 44 to the wheel housing 43. An inner ring 42b of each bearing 42 is fixed to the corresponding axel (rotating shaft) 41a by screwing a nut 45 into a thread groove formed at an outer end of the axel 41a.

A through-hole 46 is formed in the lower part of each of the longitudinally opposite ends of one side of each wheel housing 43. A mounting screw hole 47 for the lower frame 2 is formed in the upper part of each of the longitudinally opposite ends of the wheel housing 43. A screw hole 48 is formed in a rear surface of the wheel housing 43 at its lower positions to fix a roller blanket, described later.

When the wheel housings 43 constituting the pair are joined together, they form a box in which an upper and lower parts of the wheel 41 project from upper and lower central openings of the box, respectively. The wheel housings 43 constituting the pair are connected together by using a nut (not shown in the drawings) to screw a bolt 49 into the through-hole 46. Thus, a wheel supporting section (an example of a wheel device) 50 is formed which is composed of the wheel 41, the pair of bearings 42, and the pair of wheel housings 43.

Rotating shafts 55a of a lateral pair of guide rollers 55 are laterally symmetrically supported and extend in the vertical direction, and are caused to rotate by the roller blanket (an example of a supporting member) 56. The roller blanket 56 is provided with a mounting section 56a having bolt holes 57 located opposite the lateral pair of screw holes 48, formed in a rear portion of the wheel supporting section 50 at lower positions. The roller blanket 56 is connected to the rear surface of the wheel supporting section 50 (wheel housing 43) at a lower position by aligning the screw holes 48 with the corresponding bolt holes 57 and then screwing the bolts 58 into the respective bolt holes 57.

In this manner, the roller blanket 56, which supports the guide roller 55, is attached to the wheel supporting section 50 to form the wheel unit 10 having the wheel 41 and the guide rollers 55 integrated together. The wheel unit 10 is attached to the lower frame 2, formed of the square pipe, by aligning the screw holes 47, arranged in the four corners of the wheel housing 43 with corresponding through-holes (not shown in the drawings) formed in the lower frame 2 and screwing bolts 60 into the respective through-holes using the screw holes 47.

The driving wheel unit 10b is constructed by connecting the running drive device 11 to the axel (rotating shaft) 41a of the wheel unit 10 (corresponding to the driven wheel unit 10a). The running drive device 11 is composed of a motored decelerating device 63, a torque arm (an example of a supporting member) 64 that supports the motored decelerating device 63 on the lower frame 2, and a coupler 65 that couples a rotating shaft 63a of the motored decelerating device 63 and the axel (rotating shaft) 41a of the wheel unit 10 together.

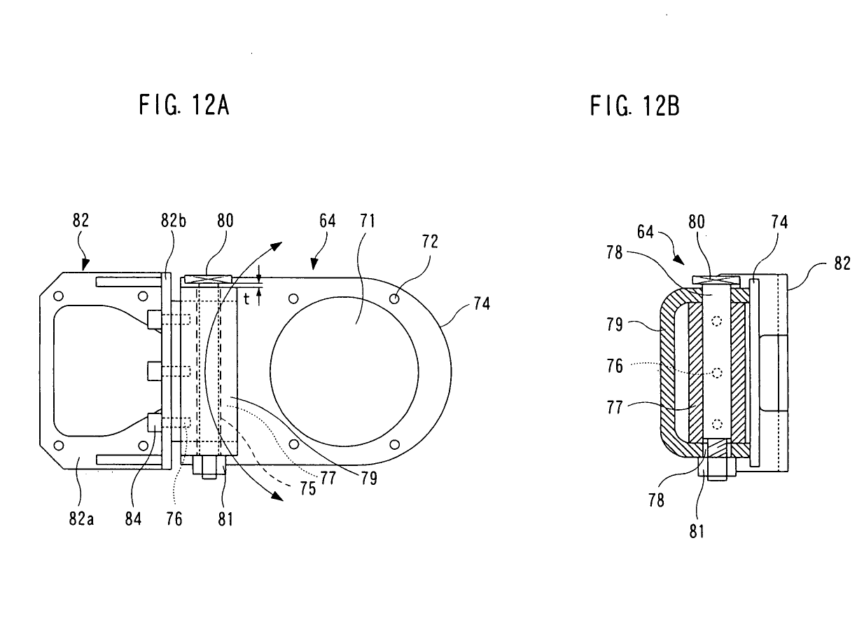

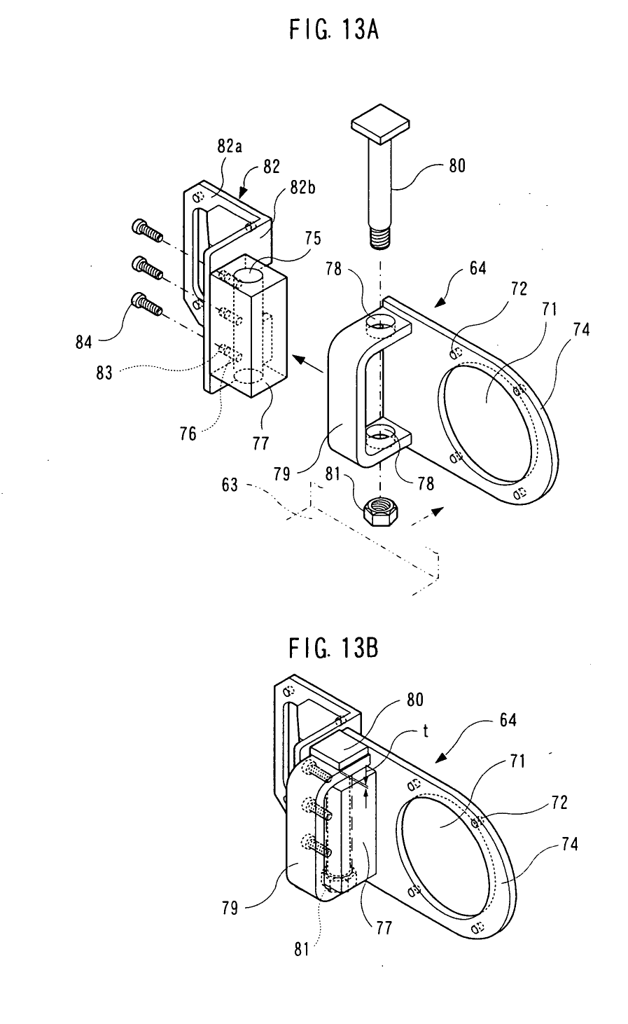

As shown in FIGS. 12 and 13, the torque arm 64 is composed of a first member 74, a second member 77, a third member 79, a pin 80, a nut 81, a bracket 82, and other components.

The first member 74 is formed like a plate and has a through-hole 71 through which the rotating shaft 63a (FIG. 11) of the motored decelerating device 63 is inserted and four through-holes 72 located opposite screw holes (not shown in the drawings) formed in sides of the motored decelerating device 63 (decelerating section). The motored decelerating device 63 (decelerating section) is fixed to the first member 74 using bolts 73 (FIG. 11) inserted through the respective through-holes 72.

The second member 77 is formed like a cylinder and has a through-hole 75 extending in the vertical direction and three screw holes 76 in its side.

The second member 77 can be placed in the third member 79 to extend in the vertical direction. The third member 79 is formed of a channel shaped plate material having through-holes 78 formed in an upper and lower surfaces and corresponding to the through-hole 75 in the second member 77. The upper and lower surfaces of the plate material have their ends fixed to one of the end surfaces of the first member 74 at its front position (an example of the longitudinal direction).

The pin 80 is formed with a thread at its tip. The pin 80 is inserted through the upper and lower through-holes 78 in the third member 79 and the through-hole 75 in the second member 77. The pin 80 allows the second member 77 to be connected to the third member 79 so that a gap (play) t is formed between the third member 79 and the second member 77.

The nut 81 is screwed over the threaded position at the tip of the pin 80.

The bracket 82 is formed of an L-shaped plate material having a fixed surface 82a fixed to the lower frame 2 and a mounting surface 82b projected in the lateral direction relative to the lower frame 2. Three through-holes 83 are formed in the mounting surface 82b opposite the respective screw holes 76 in the cylinder-like second member 77. The second member 77 is fixed to the bracket 82 to extend in the vertical direction, using bolts 84 inserted through the respective through-holes 83.

The torque arm 64 is assembled using the following procedure.

First, the three bolts 84 are used to fix the second member 77, which extends in the vertical direction, to the bracket 82. The bracket 82 is fixed to a part of the longitudinal side of the lower frame 2 which lies in front of the wheel unit 10. Then, The rotating shaft 63a of the motored decelerating device 63 is inserted through the through-hole 71. The motored decelerating device 63 (decelerating section) is then fixed to the first member 74 using the bolts 73 inserted through the respective through-holes 72. Then, the torque arm 64, formed of the first member 74 and third member 79 to which the motored decelerating device 63 is fixed, is connected to the second member 77 by placing the second member 77 in the space in the third member 79 and using the coupling members, that is, inserting the pin 80 through the upper and lower through-holes 78 in the third member 79 and the through-hole 75 in the second member 77 and then tightening the nut 81. The torque arm 64 is then attached to the bracket 82 fixed to the lower frame 2. At this time, the gap (play) t is formed in the interface between the third member 79 and the second member 77.

With the configuration of the torque arm 64, the interface between the third member 79 and second member 77 to which the motored decelerating device 63 is fixed receives a torque (shown by the arrow in FIG. 12) generated around the rotating shaft (driving shaft) 63a owing to a driving reaction force exerted when the motored decelerating device 63 rotates the (driving) wheel 41. On this occasion, the gap (play) t in the interface serves to weaken the torque acting on the second member 77 to prevent the third member 79 and the second member 77 from being damaged by a high torque. Thus, the torque is received by the interface between the third member 79 and the second member 77 and does not act on the pin 80. The pin 80 is used simply for positioning.

As shown in FIGS. 1 to 4, a first optical transmitter-receiver 91 is provided at the HP side end of the lower frame 2 to transmit and receive data to and from a ground controller 102 in the article input and output section E.

Furthermore, as shown in FIGS. 1 to 4, a leading end of a bumper (an example of a shock absorber) 92 is provided at each end (HP or OP side) of the running rail 1 and at a side of each of the longitudinally opposite ends of the square pipe forming the lower frame 2 which side is opposite the one at which the raising and lowering masts 4 are connected to the square pipe. A contact plate (an example of a contact surface) 92a of the bumper 92 is arranged to make contact between both longitudinal ends of the stacker crane C (within the machine length). This eliminates the need to increase the machine length.

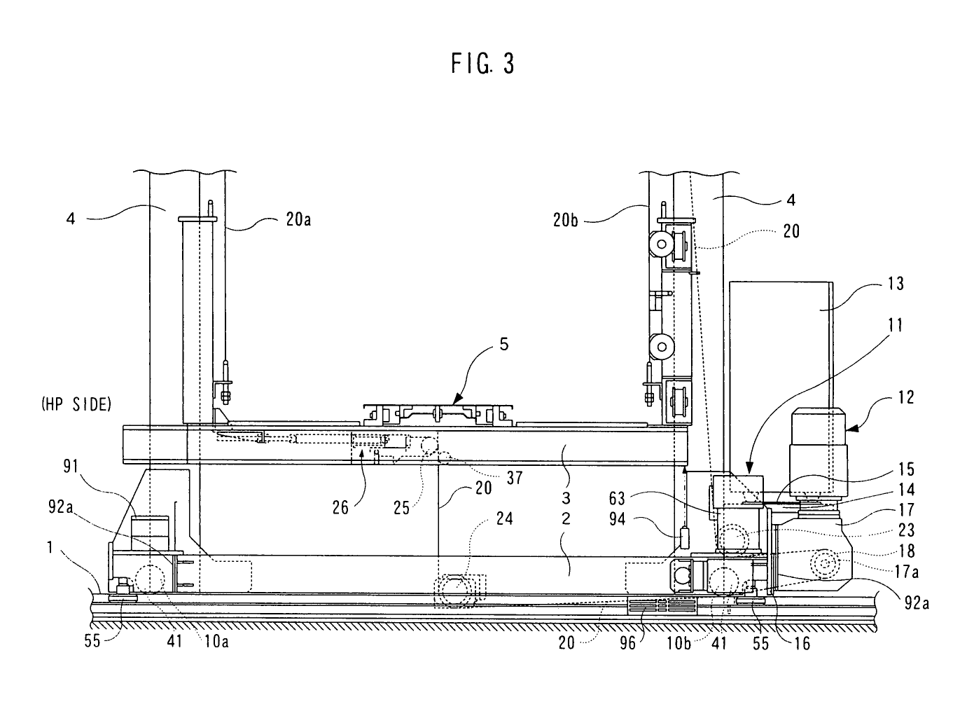

As shown in FIG. 5, a reflector 93a is provided in the lower part of the HP side of the HP side raising and lowering mast 4 to reflect a beam projected by a laser distance meter 93 (FIG. 14) installed at one end (HP side) of the work passage B. Furthermore, as shown in FIGS. 3 and 5, a laser distance meter 94 is provided at the OP side end of the lower frame 2 and extends in the vertical direction. The laser distance meter 94 projects a vertical distance measuring beam for the platform 3 and measures a distance on the basis of the light reflected by a reflector (not shown in the drawings) provided opposite the lower part of the platform 3.

As shown in FIG. 4B, a feeding rail 95 is laid at a lower end of the storage shelf A which is opposite the side to which the raising and lowering masts 4 are connected, and extends along the longitudinal direction. As shown in FIGS. 2, 4 (4B), and 5, a collector 96 to which electricity is fed through the feeding rail 95 is provided at the side of the OP side end of the lower frame 2 which side is opposite the one at which the raising and lowering masts 4 are connected to the square pipe. As shown in FIG. 14, a power supply device 97, a raising and lowering inverter 98, and a running and transfer inverter 99 provided in the control panel 13 are supplied by the collector 96 with electricity. The power supply device 97 feeds electricity to a controller 100 provided in the control panel 13.

As shown in FIG. 14, the running and transfer inverter 99 is connected to a relay 101 so as to be able to switch between the running motored decelerating device 63 and the fork device 5. The running and transfer inverter 99 drives the running motored decelerating device 63 or the fork device 5 in accordance with an instruction signal outputted by the controller 100. The raising and lowering converter 98 drives the raising and lowering motored decelerating device 17 in accordance with an instruction signal outputted by the controller 100.

The ground controller 102 is housed in a ground control panel E1. The article input and output section E is provided with a second optical transmitter-receiver 103 located opposite the first optical transmitter-receiver 91. The second optical transmitter-receiver 103 and the laser distance meter 93 are connected to the ground controller 102.

The controller 100 performs an operation of inputting or outputting the pallet P. The controller 100 receives the entry and exit data and running position data on the lower frame 2 measured by the running laser distance meter 93, from the ground controller 102 of the ground control panel E1 via the second optical transmitter-receiver 103 and the first optical transmitter-receiver 61. The controller 100 sets the elevated or lowered position of the platform 3 as a target value on the basis of the entry and exit data. The controller 100 also receives elevated or lowered position data on the platform 3 measured by the raising and lowering laser distance meter 94, as feedback data. Then, the controller 100 controls the raising and lowering motored decelerating device 17 via the raising and lowering inverter 98 to control the elevation and lowering of the platform 3. The controller 100 also sets the running position of the lower frame 2 based on the entry and exit data, as a target value. The controller 100 receives the running position data on the lower frame 2 as feedback data. The controller 100 then controls the running motored decelerating device 63 via the running and transfer inverter 99 to control the running of the lower frame 2. Moreover, to transfer the pallet P, the controller 100 switches the relay 101 to control the entry or exit of the transfer fork device 5 via the running and transfer inverter 99.

As described above, according to the present embodiment, the lower end position of each raising and lowering mast 4, formed of the square pipe, is connected to the longitudinal side of the lower frame 2, formed of the square pipe (an example of a square cylindrical member). This makes it possible to mount the wheel unit 10 (10a and 10b), which supports the lower frame 2, in the square pipe forming the lower frame 2, located opposite the raising and lowering masts 4. Accordingly, the length of the stacker crane C (machine length) can be reduced while ensuring the safety during running. Thus advantageously, the apparatus can be arranged in a small space. Furthermore, since the lower frame 2 and raising and lowering masts 4, which mainly constitute the stacker crane C, are composed of the square pipes, the weight of the whole apparatus can be reduced. This reduces transportation costs.

Moreover, according to the present embodiment, the lower end portion of each raising and lowering mast 4, formed of the square pipe, is connected to the side of the lower frame 2, formed of the square pipe. The upper end portion of the raising and lowering mast 4, formed of the square pipe, is connected to the side of the upper frame 7, formed of the square pipe. Accordingly, the height of the stacker crane C can be reduced at least by an amount corresponding to the square pipe of the upper frame 4 (the amount equal to the length of the latitudinal side of the square pipe) This is advantageous when the height to the ceiling is limited.

Furthermore, according to the present embodiment, the upper frame 7 and lower frame 2, both of which are formed of the square pipe, are respectively arranged at the same side of each raising and lowering mast 4, formed of the square pipe. This serves to appropriately balance the stacker crane C in the lateral direction. Accordingly, it is possible to reduce the burden on the guide rail 6, which guides the stacker crane C. Therefore, the guide rail 6 can advantageously be installed.

Moreover, according to the present embodiment, the laterally central position of each raising and lowering mast 4 is the substantially central position in the lateral direction of the stacker crane C, which runs in the longitudinal direction. This creates a lateral space located opposite the lower frame 2, which projects in the lateral direction from the raising and lowering mast 4. This space can be used as the work passage B or a maintenance area.

Furthermore, according to the present embodiment, the lower end of each raising and lowering mast 4 is connected to the longitudinal side of the lower frame 2. Moreover, the wheel unit 10 (10a and 10b), which supports the lower frame 2, is provided in the lower frame 2 at the same position where the corresponding raising and lowering mast 4 is connected to the lower frame 2. This makes it possible to reduce the machine length of the stacker crane C while ensuring the safety during running. Thus advantageously, the apparatus can be installed in a small space.

Furthermore, according to the present embodiment, the returning part of each raising and lowering chain 20 (20a and 20b) is guided from the fourth guide sprocket 24, located near the center of the lower frame 2, to the vicinity of the center of the platform 3 and is then connected to the chain tensioner 26 via the fifth guide sprocket 25. Thus, the returning part of the raising and lowering chain 20 (20a and 20b) is arranged sufficiently away from the front or rear raising and lowering mast 4. This prevents the returning part of the raising and lowering chain 20 from swinging to interfere with the raising and lowering mast 4 while the lower frame 2 is running. Moreover, the raising and lowering chain 20 has only to be set for the minimum tension required to prevent separation (disengagement) from the winding sprocket 18. It is thus possible to reduce the burden on the raising and lowering chain 20 as well as its chain number. The structure of the chain tensioner 26 can also be simplified (the structure that need not apply a high tension to the raising and lowering chain 20) to reduce costs.

Furthermore, according to the present embodiment, the chain tensioner 26 is arranged in the platform 3. This saves the conventional installation space for the chain tensioner in the lower frame 2. Moreover, the winding sprocket 18 and the fourth guide sprocket 24, which guide the returning part of the raising and lowering chain 20 from the winding sprocket 18, are arranged at the side of the lower frame in the longitudinal direction. This creates a space in the lower frame 2. Accordingly, the wheel unit 10 (10a and 10b), which supports the lower frame 2, can be moved inward from its conventional position and mounted inside the lower frame 2, thus reducing the length of the lower frame 10 (machine length). Consequently, the apparatus can advantageously be arranged in a small space. It is also possible to minimize the number of sprockets guiding the returning part of the raising and lowering chain 20 to reduce the number of worn parts of the raising and lowering chain 20. This serves to extend the lifetime of the raising and lowering chain 20.

Moreover, according to the present embodiment, the running drive device 11 is arranged on the longitudinal side of the lower frame 2 which is opposite the side to which the raising and lowering masts 4 are connected. Accordingly, the running drive device 10 can be disposed as close to the driving wheel unit 10b as possible, which is attached to the square pipe forming the lower frame 2, located opposite the raising and lowering masts 4.

Furthermore, according to the present embodiment, the raising and lowering drive device 12 is arranged on the lateral side (latitudinal side) of the square pipe forming the lower frame 2. Accordingly, the raising and lowering chains 20, which elevate and lower the platform 3, can be driven at the side of the lower frame 2. This enables the part of the raising and lowering chain 20 which returns from the winding sprocket 18 to be operated at the position lower than the lower frame 2, the winding sprocket 18 being driven by the raising and lowering drive device 12. This eliminates the need to provide a guide sprocket in the middle of the path of the raising and lowering chain 20 from the winding sprocket 18 to the central portion of the lower frame 2. The number of required parts can thus be reduced.

Moreover, according to the present embodiment, when an operator adjusts and inspects the stacker crane C in the work passage B (the space between the running rail 1, along which the lower frame 2 runs, and the article storage sections D), the operator can move through the work passage B more easily. This is because the sides of the control panel 13 face in the longitudinal direction to provide a large lateral spacing between the control panel 13 and the article storage sections D (storage shelf A). The operator can also perform required operations more easily because he or she can open and close the swinging door 13a of the control panel 13 in the space. This improves work efficiency. Moreover, since the sides of the control panel 13 faces in the longitudinal direction, the control panel 13 can be installed in a self-standing fashion. Consequently, the control panel 13 need not be supported by the raising and lowering masts 4.

Furthermore, according to the present embodiment, the bumper (shock absorber) 92 is arranged at each terminal of the running rail 1. A shock upon a possible collision is absorbed by the bumper 92 to avoid damaging the stacker crane C. Moreover, the contact plate 92a, which is brought into contact with the bumper 92, is arranged between the longitudinally opposite ends of the stacker crane C. This prevents the contact surface for the bumper 92 from projecting out of the machine length of the stacker crane C. Accordingly, the machine length of the stacker crane C can be reduced. Thus advantageously, the apparatus can be installed in a small space.

Furthermore, according to the present embodiment, as shown in FIG. 8, the raising and lowering chain 20 (the other end) is connected to the dogs 33, the tension springs 31, and the chain bolts 34. By adjusting the chain bolts 34 to set the tension of the tension springs 31, it is possible to set the tension of the raising and lowering chain 20 even with the simplified structure. Furthermore, the limit switch 36 is activated on the basis of the moved positions of the dogs 33 to enable it to be detected that an error has occurred in the elongation of the raising and lowering chain 20 or that the raising and lowering chain 20 has been cut. When an error in the elongation of the raising and lowering chain 20, for example, an initial elongation is detected, the raising and lowering chain 20 is checked for slack. Then, the chain bolts 34 are adjusted to reset the tension of the raising and lowering chain 20. This makes it possible to prevent the chain 20 from being disengaged from the guide sprocket 21, 22, 23, 24, or 25 or the winding sprocket 18. Furthermore, the raising and lowering chain 20 can be replaced by detecting that it has been cut.

Moreover, according to the present embodiment, as shown in FIG. 5, the winding sprocket 18 is located at the rear end of the lower frame 2 and at the side of the lower frame 2 at which the raising and lowering masts 4 are connected to the lower frame 2. The winding sprocket 18 is also arranged substantially at the height of the top surface of the lower frame 2. This eliminates the need to provide a guide sprocket in the middle of the path of the raising and lowering chain 20 from the winding sprocket 18 to the central portion of the lower frame 2. It is thus possible to reduce the number of required parts to simplify the structure.

Moreover, according to the present embodiment, the interface between the third member 79 and second member 77 to which the motored decelerating device 63 is fixed receives a torque generated around the rotating shaft (driving shaft) 63a owing to a driving reaction force exerted when the motored decelerating device 63 rotates the wheel 41. Thus, no torque acts on the pin 80, which is thus used simply for positioning. This eliminates the need to increase the diameter of the pin 80 consistently with the capacity of the motored decelerating device 63 or to separate the pin 80 from the motored decelerating device 63 as in the case of the prior art. This serves to make the torque arm 64 compact and thus allows the running drive device 11, to which the motored decelerating device 63 is added, to have a compact shape. Consequently, the running drive device 11 can be easily attached to the lower frame 2. Furthermore, the third member 79 and the second member 77 (bracket side) can be used to provide the motored decelerating device 63 with a desired strength in spite of an increase in its capacity. By thus increasing the strength of a knocked part of the motored decelerating device 63, it is possible to eliminate the need to increase the size of the motored decelerating device 63 in spite of an increase in its capacity.

Furthermore, according to the present embodiment, the gap (play) t in the interface between the third member 79 and the second member 77 serves to reduce the torque acting on the second member 77. This prevents the third member 79 and the second member 77 from being damaged by a high torque.

Moreover, according to the present embodiment, the bearings 42 constituting the pair are supported by the respective exclusive wheel housing 43. Accordingly, each wheel housing 43 can be accurately produced. It is thus unnecessary to use automatic aligning bearings as in the prior art, allowing the use of common inexpensive ball bearings. This enables the costs to be reduced. Furthermore, the wheel supporting section 50, in combination with the wheel housing 43, has a compact shape. This serves to make the wheel unit 10 compact.

Furthermore, according to the present embodiment, the longitudinal pair of wheel units 10 is compact and thus can be housed in the lower frame 2 formed of the square pipe, with enough running room left in it. Thus, as compared to the prior art in which the wheels are arranged outside the lower frame in the longitudinal direction, the machine length of the stacker crane C can be reduced. Thus advantageously, the apparatus can be installed in a small space.

Moreover, according to the present embodiment, the roller bracket 56 for the guide roller 55 is fixed to the wheel housing 43. Thus, the wheel 41 and the guide roller 55 can be integrated together. Such an integrated structure, that is, the wheel unit 10, which includes the integrated wheel 41 and guide roller 55, is attached to the lower frame 2. This facilitates attaching operations to enable the work efficiency to be improved.

In the present embodiment, the stacker crane C, which is an article conveying apparatus, comprises the lower frame 2, the platform 3, the raising and lowering masts 4, and the upper frame 7. However, the upper frame 7 may be omitted. In this case, the guide roller 8, guided along the guide rail 6 on the ceiling, is provided at the top of the corresponding raising and lowering mast 4.

In the present embodiment, the stacker crane C, which is an article conveying apparatus, has the longitudinal pair of raising and lowering masts 4 (that is, two masts). However, the longitudinal pair is not always required but the stacker crane C may have only one raising and lowering mast. In this case, the platform 3 is guided up and down along a single raising and lowering mast and is driven to ascend and descend by one raising and lowering rope (chain) for raising and lowering the platform.

Moreover, in the present embodiment, the fourth guide sprocket 24, which guides the returning part of the raising and lowering chain 20 (20a and 20b), is arranged near the center of the lower frame 2. Furthermore, the fifth guide sprocket 25, located opposite the fourth guide sprocket 24, is provided near the center of the platform 3. However, the fourth guide sprocket 24 and the fifth guide sprocket 25 have only to be provided at positions where they can guide the returning part of the raising and lowering chain 20 (20a and 20b) so that the chain 20 remains separated from the front and rear raising and lowering masts 4. In this case, the fourth guide sprocket 24 is provided in the lower frame 2 and away from the raising and lowering masts 4. The fifth guide sprocket 25 is provided in the platform 3 and away from the raising and lowering masts 4.

Furthermore, in the present embodiment, the chains are used as raising and lowering ropes. However, wires or ropes may be used instead. In this case, sheaves or pulleys may be used in place of the sprockets.

Moreover, in the present embodiment, one end of each of the raising and lowering chains 20a and 20b is fixed to the upper part of the front or rear of the platform 3. The other end is extended to the winding sprocket 18, which acts as a driving wheel, and is fixed to the lower part of the platform 3. However, a vertically movable counter weight may be provided in the hollow portion of each raising and lowering mast 4. Then, the returning part of each of the raising and lowering chains 20a and 20b guided from the winding sprocket 18 may be extended to the top of the raising and lowering mast 4 again. The other end of the chain may be connected to the counter weight.

Furthermore, in the present embodiment, in the chain tensioner 26, each of the raising and lowering chains 20a and 20b and the tension spring 31 are connected together via the dogs 33. However, the dogs 33 may be omitted. In this case, each of the raising and lowering chains 20a and 20b and the tension spring 31 are directly connected together.

Moreover, in the present embodiment, the bumper 92 is arranged at each terminal of the running rail 1 and the contact plate 92a, which is brought into contact with the bumper 92, is provided in the stacker crane C. However, conversely, the bumper 92 may be provided at the position of the stacker crane C where the contact plate 92a is otherwise mounted, whereas the contact plate 92a for the bumper 92 may be arranged at each terminal of the running rail 1, where the bumper 92 is otherwise provided.

Furthermore, in the present embodiment, the article storage section is formed of the article storage sections D of the storage shelf A. However, the article storage section need not necessarily have a shelf structure but may be adapted so that the pallets P, on which the articles F are placed, are arranged on a single level. Further, the storage shelves A, constituting the article storage section, are arranged in parallel in the lateral direction. However, the storage shelves A may be arranged only on one side. Further, each storage shelf A is configured to have the article storage sections D arranged in the longitudinal direction. However, the article storage sections D may be arranged not only in the longitudinal direction but also in the lateral direction (depth direction) . In this case, the fork device 5 is configured so that the fork (a transfer unit) can be positioned, advanced, and withdrawn with respect to the article storage sections D, arranged in the lateral direction of each storage shelf A (a double deep type).

Moreover, in the present embodiment, the fork device (an example of a transfer device) 5, which transfers the articles F, is based on a fork system, which uses a running fork. However, the fork device 5 need not be limited to the fork system. The fork device may be based on a side belt system comprising a pair of conveying belts which can be moved so that the belts approach and leave each other and which sandwiches the sides of the article F between the belts, a side clamp system comprising a pair of forks which can be moved so that the forks approach and leave each other and which transfers the article F by sandwiching its sides between the forks, a hook system that transfers the article F by gripping or supporting a handle of the article F, if any, or an arm system in which the fork moves to the rear surface of the article F and pushes this surface to transfer the article F from any of the article storage sections D to the platform 3 and in which the fork moves to the front surface of the article F and pushes this surface to transfer the article F from the platform 3 to any of the article storage sections D.

Furthermore, in the present embodiment, the pair of fixed article cradles E2a and E2b, provided in the input and output section E, are used as an entry and exit port through which the article F is conveyed. However, the article cradles E2a and E2b may be used exclusively as an entry port or exit port for the articles F. Furthermore, the article cradles E2a and E2b are used as a handling unit for the articles F. However, it is possible to use a conveyor device, an automotive carriage, an article cradle with a lifter, or the like.

Moreover, in the present embodiment, the running and transfer inverter 99 is used both by the transfer device 5 and by the running motored decelerating device 63. However, an exclusive inverter may be provided for each of the transfer device 5 and the running motored decelerating device 63.

What is claimed is:

1. An article conveying apparatus fort conveying articles between a plurality of article storage sections for storing therein the articles and a predetermined entry and exit port, the apparatus comprising:
a running truck body formed of a square cylinder and guided along a track laid along the article storage sections, to run in a longitudinal direction;
a platform provided with a transfer device for transferring articles; and
raising and lowering poles, each formed of a square cylinder, and guiding and supporting said platform to be capable of freely ascending and descending,
wherein the cylinder forming said raising and lowering pole is connected, at its lower end part, perpendicularly to a longitudinal side of the cylinder forming said running truck body.

2. An article conveying apparatus for conveying articles between a plurality of article storage sections for storing therein the articles and a predetermined entry and exit port, the apparatus comprising:
a running truck body that runs in a longitudinal direction along a track laid along the article storage sections;
a platform provided with a transfer device for transferring articles;
an upper truck body guided along an upper track laid on a ceiling to face toward the track; and
raising and lowering poles for guiding and supporting said platform to be capable of freely ascending and descending,
wherein each of said raising and lowering poles has a lower end connected to a longitudinal side of said running truck body and an upper end connected perpendicularly to a longitudinal side of said upper truck body.

3. The article conveying apparatus according to claim 2, wherein said upper truck body and said running truck body are each located on the same side of said raising and lowering poles.

4. The article conveying apparatus according to claim 2, wherein a laterally central position of said raising and lowering pole is substantially a laterally central position of the article conveying apparatus running in the longitudinal direction.

5. An article conveying apparatus for conveying articles between a plurality of article storage sections for storing therein the articles and a predetermined entry and exit port, the apparatus comprising:
a running truck body that runs in a longitudinal direction along a track laid along the article storage sections;
a platform provided with a transfer device for transferring articles; and
raising and lowering poles, each connected perpendicularly to said running truck body, and guiding and supporting said platform to be capable of freely ascending and descending,
wherein said running truck body has a longitudinal side connected to a lower end of each of said raising and lowering poles, and is supported by wheels provided in alignment with the respective positions where said raising and lowering poles are connected to the running truck body.

6. An article conveying apparatus for conveying articles between a plurality of article storage sections for storing therein the articles and a predetermined entry and exit port, the apparatus comprising:
a running truck body that runs in a longitudinal direction along a track laid along the article storage sections;
a platform provided with a transfer device for transferring articles;
a longitudinal pair of raising and lowering poles connected perpendicularly to a longitudinal side of said running truck body at respective ends of said running truck body, and guiding and supporting said platform to be capable of freely ascending and descending;
a pair of raising and lowering ropes each having one end connected to an upper part of a corresponding longitudinal side of said platform, and suspending and supporting said platform; and
a driving wheel for feeding and winding said pair of raising and lowering ropes,
wherein said raising and lowering ropes constituting the pair are each guided from the upper part of the corresponding longitudinal side of said platform to the vicinity of the center of said running truck body via said driving wheel, and has the other end connected to the vicinity of the center of said platform.

7. The article conveying apparatus according to claim 6, wherein a tension setting device is located in said platform to set a tension of said pair of raising and lowering ropes.

8. The article conveying apparatus according to claim 1, wherein a running drive device for driving wheels supporting said running truck body is disposed at a longitudinal side of said running truck body that is opposite the side at which said raising and lowering poles are connected to the running truck body.

9. The article conveying apparatus according to claim 1, wherein a raising and lowering drive device for raising and lowering said platform is located at a latitudinal side of said running truck body.

10. The article conveying apparatus according to claim 1, wherein a control panel for the article conveying apparatus having at least one swinging door provided to face in the longitudinal direction has sides extending in the longitudinal direction, and is located outside the corresponding one of said raising and lowering poles.

11. The article conveying apparatus according to claim 1, wherein a contact surface that comes into contact with a shock absorber located at a terminal end of the track is provided at a longitudinal side of each end of said running truck body and inside the corresponding one of the longitudinal ends of the running truck body.
